(19) United States
(12) Patent Application Publication
(10) Pub. No.: US 2008/0081576 A1
(43) Pub. Date: Apr. 3, 2008

(54) Multi-antenna configurations with one or more embedded antennae

(76) Inventors: Christopher N. Olsen, Beaverton, OR (US); Sandeep Gupta, Beaverton, OR (US)

Correspondence Address: INTEL/BLAKELY, 1279 OAKMEAD PARKWAY, SUNNYVALE, CA, 94085-4040, US

(21) Appl. No.: 11/529,859

(22) Filed: Sep. 28, 2006

(51) Int. Cl. H04B 1/18

(52) U.S. Cl. 455/187.1

(57) ABSTRACT

Multiple-antenna configurations with at least one embedded antenna. At least one cable in a group of antenna cables functions as an embedded antenna by being configured with some or all of a second of coaxial cable shielding being removed. Multiple embedded antennae may be provided in a multiple-antenna configuration.

### TECHNICAL FIELD

Embodiments of the invention relate to multi-antenna configurations. More particularly, embodiments of the invention relate to multi-antenna devices in which one or more of the antennae are antennae embedded within cable within the device.

### BACKGROUND

Electronic devices such as computer systems and personal digital assistants (PDAs) commonly support wireless communication functionality. The wireless functionality may support multiple wireless protocols and/or multi-antenna, multiple input/multiple output (MIMO) protocols. As the number of antennae required increases the packaging and/or management of these antennae may become more complicated.

For example, a computer system may have an antenna array for use in MIMO communications that may include three or more antennae. In order to provide satisfactory performance in terms of isolation and/or other parameters, the individual antennae may be spaced a significant distance apart. This may result in an antenna array enclosure that is relatively large, which may result in reduced user satisfaction.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a block diagram of one embodiment of an electronic system.

FIG. 2 is an illustration of one embodiment of a multi-antenna array having one embedded antenna.

FIG. 3 is an illustration of one embodiment of a multi-antenna array having two embedded antennae.

FIG. 4 is an illustration of one embodiment of a multi-antenna array having three embedded antennae.

FIG. 5 illustrates one embodiment of an embedded antenna.

FIG. 6 illustrates one embodiment of an embedded slot antenna.

FIG. 7 illustrates one embodiment of an embedded planar inverted F antenna (PIFA).

### DETAILED DESCRIPTION

In the following description, numerous specific details are set forth. However, embodiments of the invention may be practiced without these specific details. In other instances, well-known circuits, structures and techniques have not been shown in detail in order not to obscure the understanding of this description.

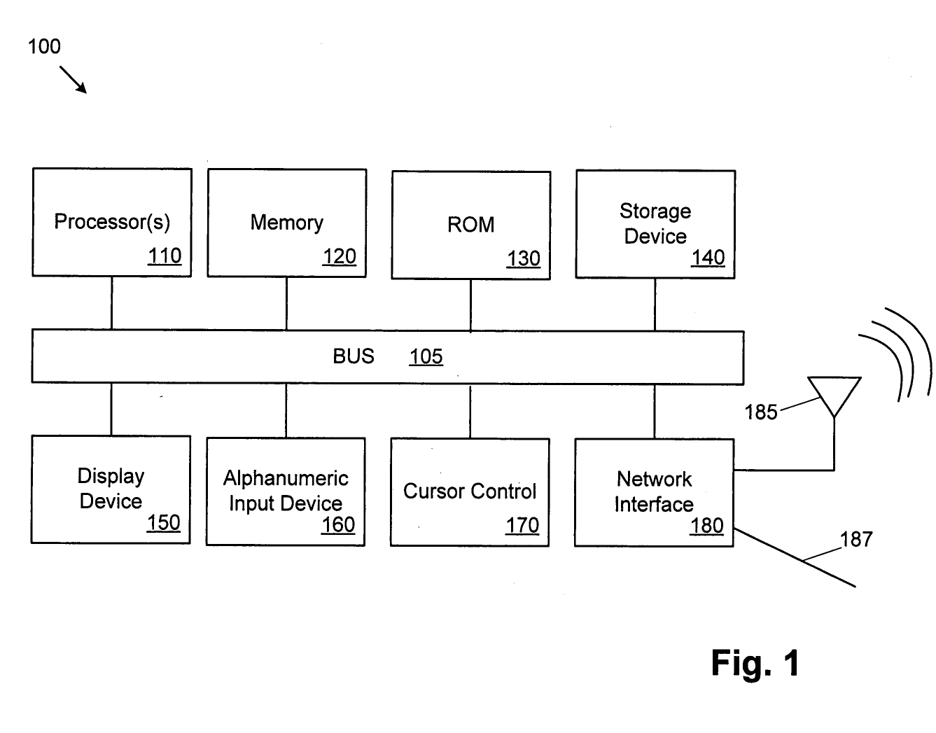

FIG. 1 is a block diagram of one embodiment of an electronic system. The electronic system illustrated in FIG. 1 is intended to represent a range of electronic systems (either wired or wireless) including, for example, desktop computer systems, laptop computer systems, cellular telephones, personal digital assistants (PDAs) including cellular-enabled PDAs, set top boxes. Alternative electronic systems may include more, fewer and/or different components.

Electronic system 100 includes bus 105 or other communication device to communicate information, and processor 110 coupled to bus 105 that may process information. While electronic system 100 is illustrated with a single processor, electronic system 100 may include multiple processors and/or co-processors. Electronic system 100 further may include random access memory (RAM) or other dynamic storage device 120 (referred to as main memory), coupled to bus 105 and may store information and instructions that may be executed by processor 110. Main memory 120 may also be used to store temporary variables or other intermediate information during execution of instructions by processor 110.

Electronic system 100 may also include read only memory (ROM) and/or other static storage device 130 coupled to bus 105 that may store static information and instructions for processor 110. Data storage device 140 may be coupled to bus 105 to store information and instructions. Data storage device 140 such as a magnetic disk or optical disc and corresponding drive may be coupled to electronic system 100.

Electronic system 100 may also be coupled via bus 105 to display device 150, such as a cathode ray tube (CRT) or liquid crystal display (LCD), to display information to a user. Alphanumeric input device 160, including alphanumeric and other keys, may be coupled to bus 105 to communicate information and command selections to processor 110. Another type of user input device is cursor control 170, such as a mouse, a trackball, or cursor direction keys to communicate direction information and command selections to processor 110 and to control cursor movement on display 150.

Electronic system 100 further may include network interface(s) 180 to provide access to a network, such as a local area network. Network interface(s) 180 may include, for example, a wireless network interface having antenna 185, which may represent one or more antenna(e). Network interface(s) 180 may also include, for example, a wired network interface to communicate with remote devices via network cable 187, which may be, for example, an Ethernet cable, a coaxial cable, a fiber optic cable, a serial cable, or a parallel cable.

In one embodiment, network interface(s) 180 may provide access to a local area network by conforming to IEEE 802.16 standards. IEEE 802.16 corresponds to IEEE 802.15-2005 entitled “Air Interface for Fixed Broadband Wireless Access Systems” approved Dec. 7, 2005 as well as related documents.

In one embodiment, network interface(s) 180 may provide access to a local area network, for example, by conforming to IEEE 802.11b and/or IEEE 802.11g standards, and/or the wireless network interface may provide access to a personal area network, for example, by conforming to Bluetooth standards. Other wireless network interfaces and/or protocols can also be supported.

IEEE 802.11b corresponds to IEEE Std. 802.11b-1999 entitled “Local and Metropolitan Area Networks, Part 11: Wireless LAN Medium Access Control (MAC) and Physical Layer (PHY) Specifications: Higher-Speed Physical Layer Extension in the 2.4 GHz Band,” approved Sep. 16, 1999 as well as related documents. IEEE 802.11g corresponds to IEEE Std. 802.11g-2003 entitled “Local and Metropolitan Area Networks, Part 11: Wireless LAN Medium Access Control (MAC) and Physical Layer (PHY) Specifications, Amendment 4: Further Higher Rate Extension in the 2.4 GHz Band,” approved Jun. 27, 2003 as well as related documents. Bluetooth protocols are described in “Specification of the Bluetooth System: Core, Version 1.1,” published Feb. 22, 2001 by the Bluetooth Special Interest Group, Inc. Associated as well as previous or subsequent versions of the Bluetooth standard may also be supported.

In addition to, or instead of, communication via wireless LAN standards, network interface(s) 180 may provide wireless communications using, for example, Time Division, Multiple Access (TDMA) protocols, Global System for Mobile Communications (GSM) protocols, Code Division, Multiple Access (CDMA) protocols, and/or any other type of wireless communications protocol.

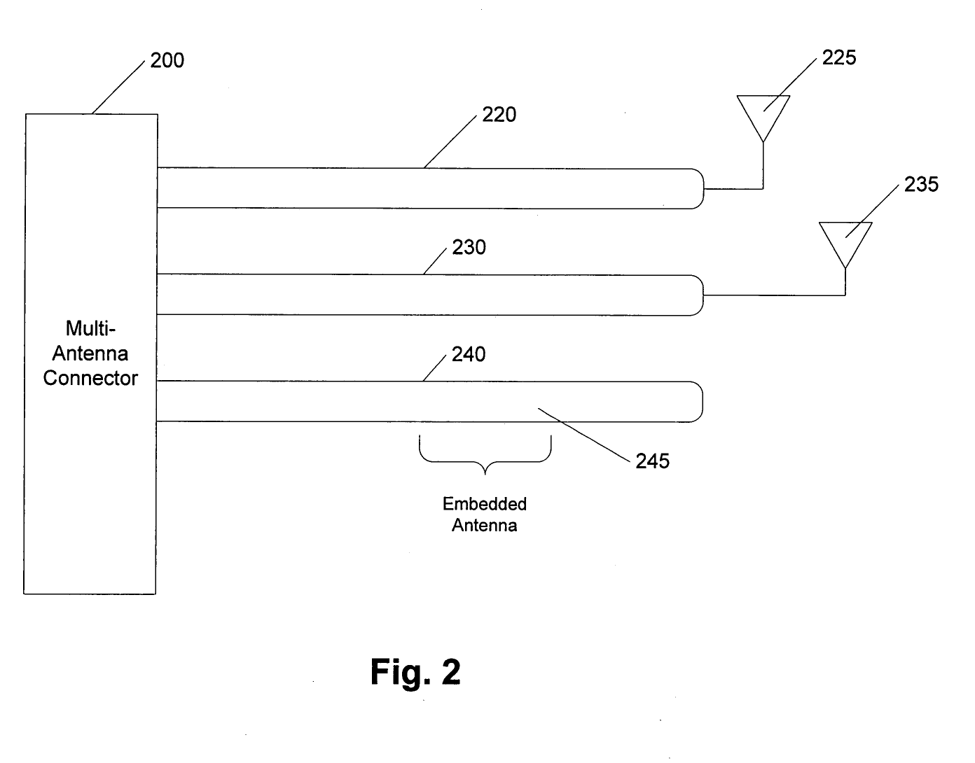

FIG. 2 is an illustration of one embodiment of a multi-antenna array having one embedded antenna. In one embodiment the multi-antenna array may be used to support IEEE 802.16 compliant communications, which included MIMO-based communications techniques. Other antenna types, for example, Bluetooth and/or WLAN antennae may also be included in the multi-antenna array.

The multi-antenna array may include multi-antenna connector 200 that provides a physical interface to a host system. Multi-antenna connector 200 may be any type of interface that allows a host system to send and receive wireless signals. In one embodiment, the multi-antenna array may include three or more cables (e.g., 220, 230, 240) that may carry signals between multi-antenna connector 200 and the respective antennae (e.g., 225, 235, 245). Multi-antenna connector 200 may be, for example, an RJ-type connector, a USB connector, etc.

In one embodiment, two cables (220 and 230) may be coupled between multi-antenna connector 200 and individual antennas (225 and 235, respectively) in a multi-antenna array. Cable 220 may be any appropriate type of electrical connection between multi-antenna connector 200 and antenna 225. Similarly, cable 230 may be any appropriate type of electrical connection between multi-antenna connector 200 and antenna 235.

Cable 240 may be a coaxial cable configured to include embedded antenna 245. Example embodiments of an embedded antenna are described in greater detail below. In general, an embedded antenna is an antenna structure that part of a cable.

In order to provide sufficient isolation (e.g., −30 db, −25 db, −27 db) and pattern coverage with three antennae, physical separation between the three or more antenna may be desirable. The separation required to achieve the desired isolation may be dependent on, for example, frequency range used, power levels, etc. In one embodiment, antenna 225 may be physically separated form antenna 235 by some distance (e.g., 6 inches, 8 inches, 4 inches) to provide sufficient isolation.

In one embodiment, antenna 225, antenna 235 and possibly additional antennae (not illustrated in FIG. 2) may be housed in a single package that may be coupled to a host electronic system via cables 220 and 230. In one embodiment, one or more of cables 220, 230 and 240 may be grouped together in a “ganged cable” arrangement. In one embodiment, antenna 225 and antenna 235 may have different polarities. For example, antenna 225 may have a horizontal polarity while antenna 235 may have a vertical polarity.

The physical configuration of embedded antenna 245 in cable 240 may be selected to provide sufficient isolation. For example, embedded antenna 245 may be physically separated from antenna 225 and/or antenna 235. Embedded antenna 245 may be several inches (e.g., 4 inches, 6 inches, 8 inches) from antenna 225 and antenna 235. The separation between embedded antenna 245 and antenna 225 or antenna 235 may be selected based on, for example, the frequency range of signals transmitted and/or received, power levels, etc.

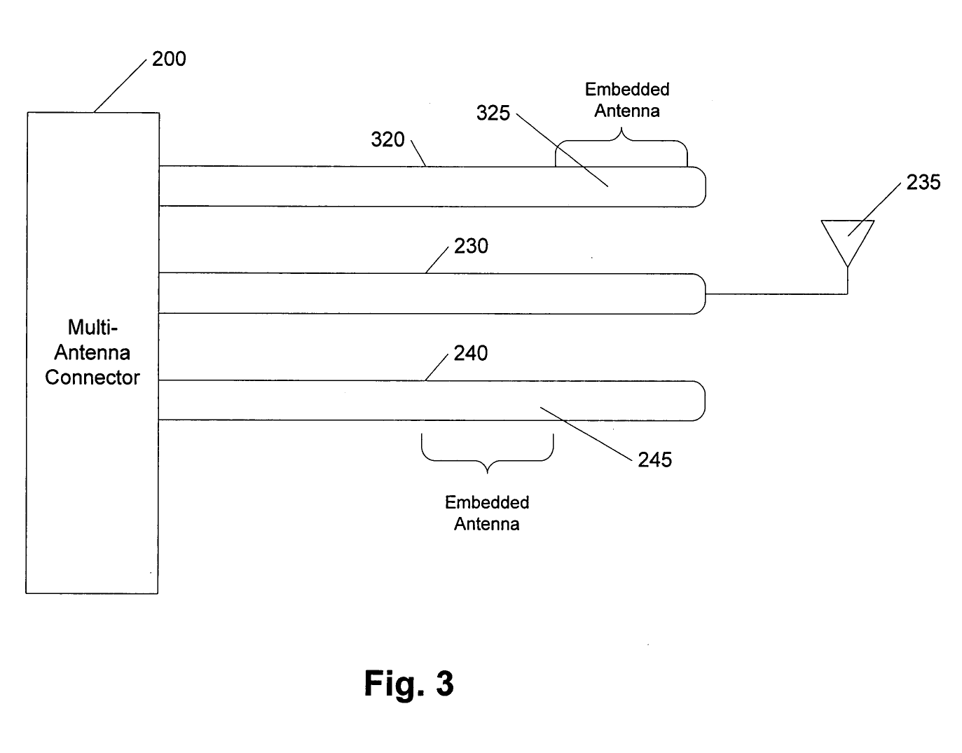

FIG. 3 is an illustration of one embodiment of a multi-antenna array having two embedded antennae. In one embodiment the multi-antenna array may be used to support IEEE 802.16 compliant communications, which included MIMO-based communications techniques. Other antenna types, for example, Bluetooth and/or WLAN antennae may also be included in the multi-antenna array.

The multi-antenna array may include multi-antenna connector 200 as described above. In one embodiment, the multi-antenna array may include three or more cables (e.g., 320, 230, 240) that may carry signals between multi-antenna connector 200 and the respective antennae (e.g., 325, 235, 245).

Cable 320 may be a coaxial cable configured to include embedded antenna 325. Cable 230 may be any appropriate type of electrical connection between multi-antenna connector 200 and antenna 235. Cable 240 may be a coaxial cable configured to include embedded antenna 245. Example embodiments of an embedded antenna are described in greater detail below.

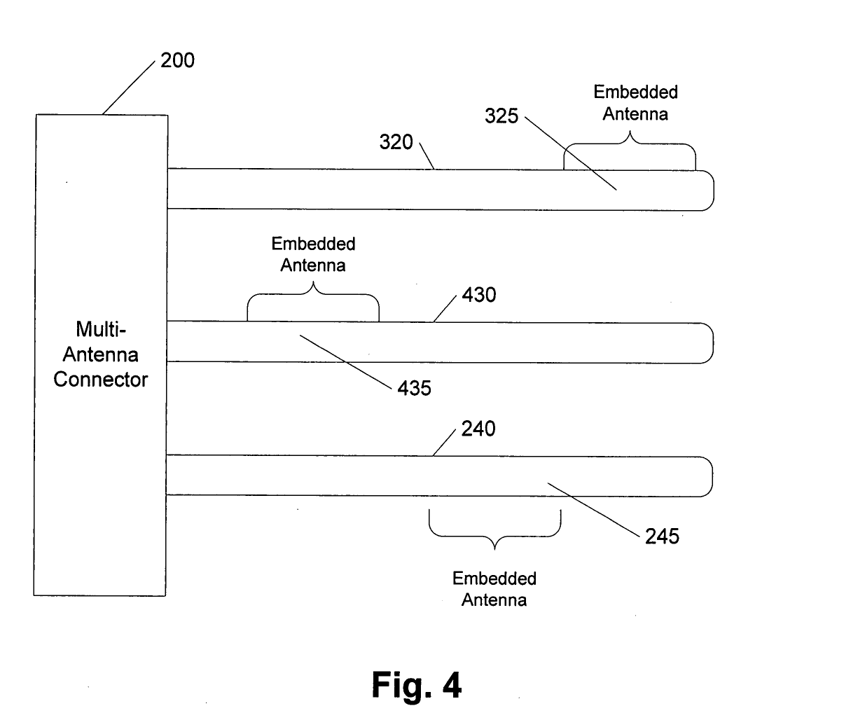

In one embodiment, antenna 235 and possibly additional antennae (not illustrated in FIG. 4) may be housed in a single package that may be coupled to a host electronic system via cable 230. In one embodiment, one or more of cables 320, 230 and 240 may be grouped together in a ganged cable arrangement. The physical configuration of embedded antenna 245 in cable 240 and embedded antenna 325 in cable 320 may be selected to provide desired isolation. For example, embedded antenna 245 may be physically separated from antenna 235. Similarly, embedded antenna 325 may be physically separated form antenna 235 and embedded antenna 245. Embedded antenna 325 may be several inches (e.g., 4 inches, 6 inches, 8 inches) from antenna 235 and embedded antenna 245. The separation between embedded antenna 325 and embedded antenna 245 and/or antenna 235 may be selected based on, for example, the frequency range of signals transmitted and/or received, power levels, etc.

FIG. 4 is an illustration of one embodiment of a multi-antenna array having three embedded antennae. In one embodiment the multi-antenna array may be used to support IEEE 802.16 compliant communications, which included MIMO-based communications techniques. Other antenna types, for example, Bluetooth and/or WLAN antennae may also be included in the multi-antenna array.

The multi-antenna array may include multi-antenna connector 200 as described above. In one embodiment, the multi-antenna array may include three or more cables (e.g., 320, 430, 240) that may carry signals between multi-antenna connector 200 and the respective antennae (e.g., 325, 435, 245).

Cable 430 may be a coaxial cable configured to include embedded antenna 435. Cables 240 and 320 may be coaxial cables configured to include embedded antennae 245 and 325 as described above. Example embodiments of an embedded antenna are described in greater detail below.

In one embodiment, one or more of cables 320, 430 and 240 may be grouped together in a ganged cable arrangement. The physical configuration of embedded antenna 435, embedded antenna 245 in cable 240 and embedded antenna 325 in cable 320 may be selected to provide desired isolation. For example, embedded antenna 245 may be physically separated from embedded antenna 435. Similarly, embedded antenna 325 may be physically separated form embedded antenna 435 and embedded antenna 245. Each embedded antenna may be several inches (e.g., 4 inches, 6 inches, 8 inches) from other antennae. The separation between embedded antenna 435 and embedded antenna 245 and/or embedded antenna 325 may be selected based on, for example, the frequency range of signals transmitted and/or received, power levels, etc.

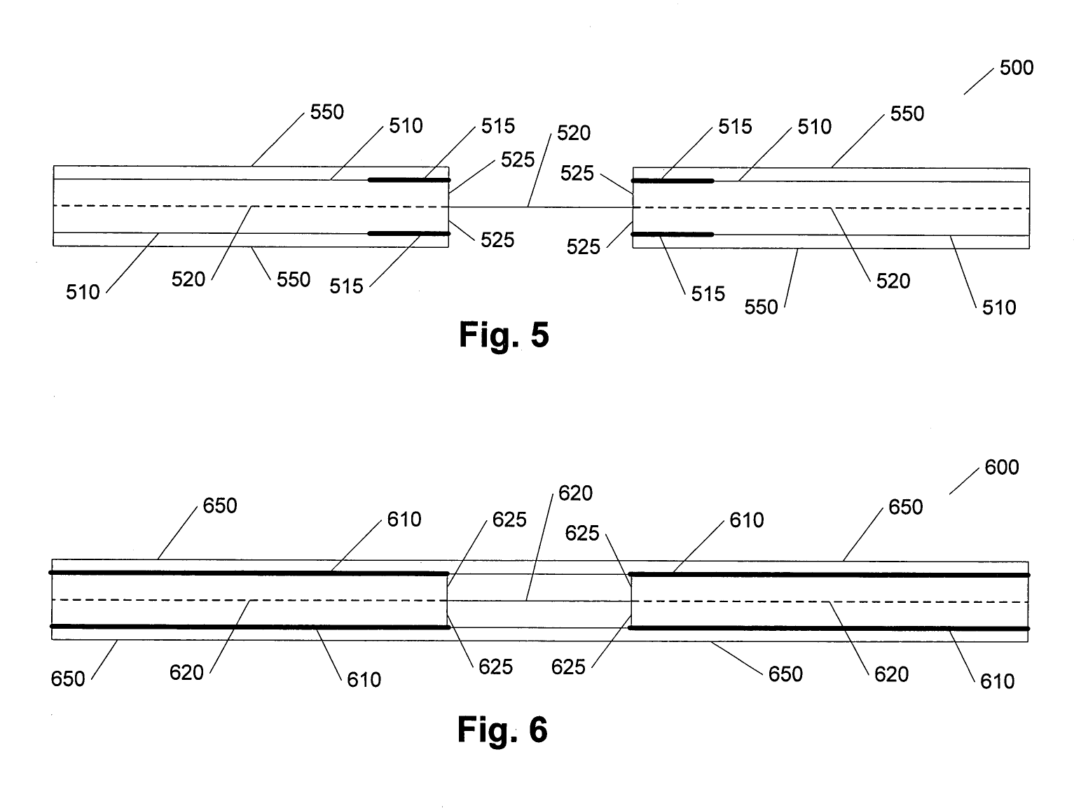

FIG. 5 illustrates one embodiment of an embedded antenna. One or more of the embedded antennae described above may be implemented as the embedded antenna of FIG. 5. Coaxial cable 500 includes conductor 520, which may be copper wire or other suitable conductive material, surrounded by insulating material 525. Any appropriate insulating material known in the art may be used.

Insulating material 525 may be surrounded by conductive layer 510 that may be, for example, a copper mesh or other suitable conductive material. In one embodiment, conductive layer 510 may include additional material 515 that may be used to tune the embedded antenna. Conductive layer 510 may be surrounded by outer insulation material 550. Any material known in the art suitable for insulation and/or protection of the structure of coaxial cable 500 may be used for outer insulation material 550.

An embedded antenna may be created by removing insulating material 525, conductive layer 510 and/or outer insulation material 550 to expose a portion of conductor 520. The size of the exposed portion of conductor 520 may be determined based, at least in part, on the frequency used for wireless communications. In one embodiment, communications are in the 2.4 GHz and/or 5 GHz range; however, any frequency range can be supported with an embedded antennae. In one embodiment, current may be oscillated between conductor 520 and conductive layer 510 to cause the embedded antenna structure to function as an antenna. In various embodiments, the insulating, non-conductive portion of the cable may be retained for strength, shape and/or flexibility concerns.

In alternate embodiments, one or more portions of multiple coaxial cables may be used to change the mode of the embedded antenna. For example, the structure of FIG. 5 may be juxtaposed with another coaxial cable having a conductive layer that may be incorporated into the antenna design of the embedded antenna. Other alternative configurations may also be used.

FIG. 6 illustrates one embodiment of an embedded slot antenna. One or more of the embedded antennae described above may be implemented as the embedded antenna of FIG. 6. Coaxial cable 600 includes conductor 620, which may copper wire or other suitable conductive material, surrounded by insulating material 625. Any appropriate insulating material known in the art may be used.

Insulating material 625 may be surrounded by conductive layer 610 that may be, for example, a copper mesh or other suitable conductive material. Conductive layer 610 may be surrounded by outer insulation material 650. Any material known in the art suitable for insulation and/or protection of the structure of coaxial cable 600 may be used for outer insulation material 650.

An embedded antenna may be created by removing insulating material 625, conductive layer 610 and only a portion of outer insulation material 650 to create an aperture or slot to expose a portion of conductor 620. This may result in a “slot” embedded antenna. The size of the aperture or exposed portion of conductor 620 may be determined based, at least in part, on the frequency used for wireless communications. In one embodiment, communications are in the 2.4 GHz and/or 5 GHz range; however, any frequency range can be supported with an embedded slot antennae. In one embodiment, current may be oscillated between conductor 620 and conductive layer 610 to cause the embedded antenna structure to function as an antenna.

In alternate embodiments, one or more portions of multiple coaxial cables may be used to change the mode of the embedded antenna. For example, the structure of FIG. 6 may be juxtaposed with another coaxial cable having a conductive layer that may be incorporated into the antenna design of the embedded antenna. Other alternative configurations may also be used.

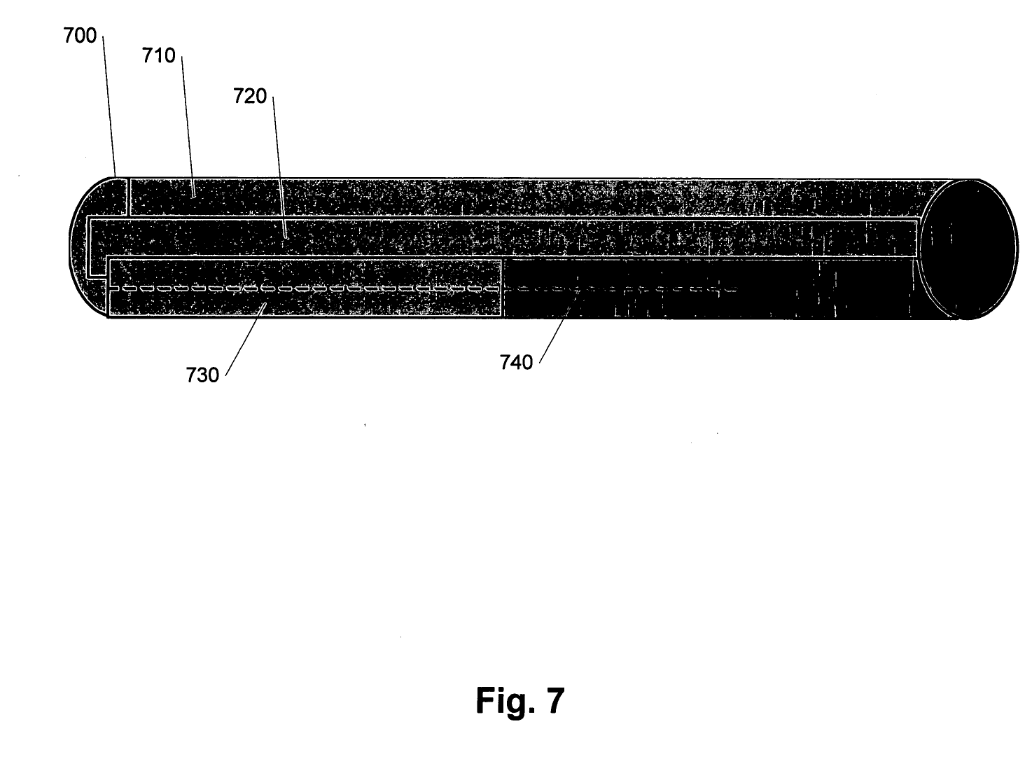

FIG. 7 illustrates one embodiment of an embedded planar inverted F antenna (PIFA). One or more of the embedded antennae described above may be implemented as the embedded antenna of FIG. 7. In one embodiment, at least three coaxial cables, 710, 720 and 730 are bundled within a single sheath 700. Conductor 740 of coaxial cable 730 may function as a PIFA radiating element and the internal conductive layers of coaxial cables 710 and 720 may function as shield/ground planes that may allow the exposed portion of conductor 740 to function as a PIFA radiating element. Additional conductive material may be added, for example, as a sleeve that can be used to tune the PIFA antenna structure.

Another type of embedded cable antenna may include multiple radiating elements with assigned frequencies of operation along the length of a single coaxial cable of bundle of coaxial cable or other impedance controlled cable. The position of the radiating elements corresponding to higher frequencies may be injected into the cable to reduce the cable loss at higher frequencies. The positioning of the radiating elements may be arranged to provide the desired isolation between elements or away from the driving components, which may be a source of interference.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. An apparatus comprising:
a plurality of antennae;
a first cable coupled with a first antenna in the plurality of antennae;
a coaxial cable having an embedded antenna to function as a second antenna in the plurality of antennae.

2. The apparatus of claim 1 further comprising a third cable coupled with a third antenna in the plurality of antennae.

3. The apparatus of claim 2 wherein the first antenna and the third antenna have different polarity.

4. The apparatus of claim 2 wherein the first antenna, the second antenna and the third antenna belong to an antenna array configured to communicate utilizing a multiple input, multiple output (MIMO) wireless communication protocol.

5. The apparatus of claim 1 wherein the embedded antenna comprises a portion of the coaxial cable having no shielding material.

6. The apparatus of claim 5 wherein at least a subset of the plurality of antennae are configured to communicate according to IEEE 802.16 compliant protocols.

7. The apparatus of claim 1 wherein the embedded antenna comprises a portion of the coaxial cable having at least some of the shielding material removed.

8. The apparatus of claim 1 further comprising a second coaxial cable having a second embedded antenna to function as a third antenna in the plurality of antennae.

9. The apparatus of claim 8 wherein the first antenna, the second antenna and the third antenna belong to an antenna array configured to communicate utilizing a multiple input, multiple output (MIMO) wireless communication protocol.

10. The apparatus of claim 8 wherein the second embedded antenna comprises a portion of the second coaxial cable having no shielding material.

11. A system comprising:
a bus;
a processor coupled with the bus;
a wired network interface coupled with the bus;
an Ethernet cable coupled with the wired network interface;
a wireless network interface coupled with the bus, the wireless network interface having a first cable coupled with a first antenna in a plurality of antennae and a coaxial cable having an embedded antenna to function as a second antenna in the plurality of antennae.

12. The system of claim 11 further comprising a third cable coupled with a third antenna in the plurality of antennae.

13. The system of claim 12 wherein the first antenna and the third antenna have different polarity.

14. The system of claim 12 wherein the first antenna, the second antenna and the third antenna belong to an antenna array configured to communicate utilizing a multiple input, multiple output (MIMO) wireless communication protocol.

15. The system of claim 14 wherein at least a subset of the plurality of antennae are configured to communicate according to IEEE 802.16 compliant protocols.

16. The system of claim 11 wherein the embedded antenna comprises a portion of the coaxial cable having no shielding material.

17. The system of claim 11 further comprising a second coaxial cable having a second embedded antenna to function as a third antenna in the plurality of antennae.

18. The system of claim 17 wherein the first antenna, the second antenna and the third antenna belong to an antenna array configured to communicate utilizing a multiple input, multiple output (MIMO) wireless communication protocol.

19. The system of claim 17 wherein the second embedded antenna comprises a portion of the second coaxial cable having no shielding material.

20. An apparatus comprising:
a first coaxial cable having a first embedded antenna to function as a first antenna in a plurality of antennae; and
a second coaxial cable bundled with the first coaxial cable, the second coaxial cable having a second embedded antenna to function as a second antenna in the plurality of antennae.

21. The apparatus of claim 20 further comprising a third coaxial cable bundled with the first coaxial cable and with the second coaxial cable having a third embedded antenna to function as a third antenna in the plurality of antennae.

22. The apparatus of claim 21 wherein the first embedded antenna, the second embedded antenna and the third embedded antenna are configured to communicate according to IEEE 802.16 compliant protocols.

23. The apparatus of claim 21 wherein the first embedded antenna, the embedded second antenna and the third embedded antenna belong to an antenna array configured to communicate utilizing a multiple input, multiple output (MIMO) wireless communication protocol.

24. The apparatus of claim 20 wherein the first embedded antenna comprises a portion of the second coaxial cable having no shielding material.

25. The apparatus of claim 20 wherein the first embedded antenna comprises a portion of the coaxial cable having at least some of the shielding material removed.
